(19) United States
(12) Patent Application Publication
(10) Pub. No.: US 2003/0178222 A1
(43) Pub. Date: Sep. 25, 2003

(54) Cable or cable component coated with a water swellable material

(76) Inventors: Simon Moore, Dartford (GB); Gavin Leslie Morland, Greenhithe Valley (GB); Michael anthony Stradling, Sidcup (GB)

Correspondence Address: BP America Inc, Docket Clerk, Law Department Mail Code 2207A, 200 E Randolph Drive, Chicago, IL, 60601-7125, US

(21) Appl. No.: 10/297,502

(22) PCT Filed: May 29, 2001
(86) PCT No.: PCT/GB01/02360

(30) Foreign Application Priority Data
Jun. 7, 2000 (GB) 0013845.3

(51) Int. Cl. H01B 7/00

(52) U.S. Cl. 174/120 R

(57) ABSTRACT

A cable or cable component having a water swellable coating prepared from a pourable, radiation curable, liquid composition which has been subjected to radiation curing. The pourable, radiation curable, liquid composition comprises an ethylenically unsaturated polymer dissolved in a monomer. The ethylenically unsaturated polymer has radiation potymerisable functionatity.

This invention concerns a cable or a cable component coated with a water swellable material.

Ingress of water into cables causes many problems: in power cables, ingress of water can cause poor electrical properties; in copper transmission cables, ingress of water can cause signal loss; and in optical cables, ingress of water can cause poor transmission.

Preventing ingress of water into cables has been approached in many ways. Originally petroleum jellies and filling compounds such as soft greases and oils were used to prevent water entering cables. More recently these materials have been improved by the addition of materials known as super absorbent polymers (‘SAP’s) which swell to many times their original volume in the presence of water. These materials are messy to use and it is difficult to join cables which are covered in these materials.

Coatings of powders of super absorbent polymers have also been applied to cables to prevent ingress of water. These powders can, however, produce a hazardous dust. Furthermore, only thick coatings can be produced, which is costly and affects line speed in production.

The aim of the present invention is to provide an improved method for water blocking cables or cable components.

In accordance with the present invention there is provided a cable or cable component having a water swellable coating prepared from a pourable, radiation curable, liquid composition which has been subjected to radiation curing; the pourable, radiation curable, liquid composition comprising an ethylenically unsaturated polymer dissolved in a monomer; the ethylenically unsaturated polymer having radiation polymerisable functionality.

In accordance with the present invention there is also provided a cable or cable component coated with a pourable, radiation curable, liquid-composition comprising an ethylenically unsaturated polymer dissolved in a monomer; the ethylenically unsaturated polymer having radiation polymerisable functionality.

In accordance with the present invention there is also provided a method of coating a cable or cable component with a water swellable coating, the method comprising the steps of:

coating the cable or cable component with a pourable, radiation curable, liquid composition comprising an ethylenically unsaturated polymer dissolved in a monomer; the ethylenically unsaturated polymer having radiation polymerisable functionality; and

subjecting the coated cable or cable component to radiation in order to cure the pourable, radiation curable, liquid composition.

By the term ‘cable’ we include cables such as, for example, fibre-optic cables, power cables, copper telecommunication cables, and blown fibre units.

By the term ‘cable component’ we include for fibre-optic cable components such as, for example, strength members (which are usually made from glass, reinforced plastic or compacted steel); tubes (which are usually made from polymers such as, for example, polyester, polyolefins, polyethylenes, PVC; or metals such as, for example, steel, aluminium, or stainless steel); optical fibres; optical ribbon fibres; tapes (which are usually made from glass, aramid, steel, aluminium and non-wovens); yarns (which are usually made from polymeric materials such as, for example, polyethylene, PVC, nylon, ethylene-propylene-diene monomers); conductors; and rip cords.

By the term ‘cable component’ we include for power cables components such as, for example, conductors, tape, under sheath and over sheath.

By the term ‘cable component’ we include for copper telecommunication cables components such as, for example, insulated conductors, tapes, strength members, yarns, and sheathing materials.

Preferably, the pourable liquid, radiation curable composition is water swellable upon radiation curing.

The pourable liquid, radiation curable composition may additionally comprise one or more photoinitiators and/or photosensitisers, and/or an organic acid.

The pourable liquid, radiation curable composition may further comprise at least one of the following components: a base; an inorganic salt; a small amount of water or organic solvent; a blowing or foaming agent; a surfactant or dispersant; adhesion promoter or tackifying resin; a fibre or filler; and a crosslinking agent.

Other possible additives for the pourable liquid, radiation curable composition include coupling agents, air release agents, inhibitors, wetting agents, lubricants or waxes, stabilisers, antioxidants and pigments.

The type of coating produced on the cable or cable component will depend on a number of factors which include, for example, processing speed, coating thickness, water swelling or blocking response in terms of speed and extent, the type of cable or cable component to which the coating is applied, and the nature of solutions in which it is required to function (ie. absorb).

The cable or cable component may be coated by using, for example, one of the following methods: spraying, dipping, co-extrusion, die-coating, sponge-coating, pad-coating, printing (e.g. gravure, flexography, lithography, letter press, letter set, screen printing and ink jet printing) or pattern printing.

The thickness of the coating on the cable or cable component depends on the cable design, including cable geometry, swell ratio of the coating, and relative speed of swell of the coating.

The radiation polymerisable polymer, which may be referred to as a prepolymer, as in a polymer which contains ethylenic unsaturation such that it can be further polymerised, may be formed in two stages. Firstly, a monomer or monomers selected from groups below may be polymerised to form a polymer backbone, then secondly unsaturated functionalities are introduced into the polymer backbone. This unsaturated functionality provides the prepolymer with the radiation polymerisable functionality.

The polymer backbone may be formed from monomer or monomers selected from groups consisting of:

C₁ to C₂₀alkyl (meth) acrylates, preferably C₁ to C₅alkyl (meth) acrylates, eg methyl methacrylate;

(meth) acrylates having mono- or multi-carboxylic acid or sulphonic acid functionality e.g. acrylic acid or anhydride, ss-carboxy ethyl acrylate (ss-CEA), maleic acid, fumaric acid or itaconic acid (or anhydrides thereof);

salts of the acid functional (meth) acrylates with-sodium, potassium, ammonium as the counter-ion eg sodium acrylate, ammonium acrylate, sodium 2-sulphoethoxy acrylate. Salts of the acid functional acrylates with other bases including organic bases such as amines e.g. triethylamine, methyl morpholine, hydroxyethyldiethylamine, tnethanolamine, hydroxyethyl morpholine, tris (dimethylaminomethyl) phenol;

(meth) acrylates having a hydroxy functional group eg. hydroxy ethyl acrylate (HEA), hydroxy ethyl (meth) acrylate (HEMA), hydroxy propyl acrylate (HPA); acrylated epoxides eg glycidyl (meth)acrylate, acrylated amino alcohols and alkoxylated amines such as those which may be prepared in-situ by simple mixing of, for example, acid functional acrylate and a hydroxyl functional primary amine;

acrylamide and its derivatives eg N-hydroxymethylacrylamide, N-tris(hydroxymethyl)methyl acrylamide, other N-alkyl or N-alkoxy substituted acrylamides eg N,N-dimethyl acrylamide and acrylamide derivatives such as acrylamidosulphonic acid and its salts;

ether and polyether (meth) acrylates such as monoacrylates having alkoxylated chains e.g. ethoxy or poly ethylene oxide structure e.g. polyethylene glycol monoacrylates, preferably methoxy polyethyleneglycol 350 methacrylate, polypropylene glycol monoacrylates (egSR 607 from Sartomer Co), ethoxy ethoxyethyl acrylate (EOEOEA), ethyltriethylene glycol methacrylate, ethoxylated phenoxy ethyl acrylate, monomethoxy neopentyl glycol propoxylate monoacrylate (Photomer 8127 from Henkel);

amino-(meth) acrylates or amine-(meth) acrylate salts, eg N,N-dimethylaminoethyl acrylate (DMAEA), tertiary-butylaminoethyl methacrylate; hydrochloride or toluene sulphonate or other salt of DMAEA; and

unsaturated acid chlorides, preferably (meth)acryloyl chloride.

Preferred polymer backbones, i.e. the prepolymer as it exists before the introduction of unsaturated functionalities, are formed from monomers selected from groups consisting of:

C₁ to C₂₀alkyl (meth) acrylates, preferably C₁ to C₅alkyl (meth) acrylates, eg methyl methacrylate;

(meth) acrylates having mono- or multi-carboxylic acid or sulphonic acid functionality e.g. acrylic acid or anhydride, ss-carboxy ethyl acrylate (ss-CEA), maleic acid, fumaric acid or itaconic acid (or anhydrides thereof);

(meth) acrylates having a hydroxy functional group eg. hydroxy ethyl acrylate (HEA), hydroxy ethyl (meth) acrylate (HEMA), hydroxy propyl acrylate (HPA); acrylated epoxides eg glycidyl (meth)acrylate, acrylated amino alcohols and alkoxylated amines such as those which may be prepared in-situ by simple mixing of, for example, acid functional acrylate and a hydroxyl functional primary amine;

acrylamide and its derivatives eg N-hydroxymethylacrylamide, N-tris(hydroxymethyl)methyl acrylamide, other N-alkyl or N-alkoxy substituted acrylamides eg N,N-dimethyl acrylamide and acrylamide derivatives such as acrylamidosulphonic acid and its salts;

ether and polyether (meth) acrylates such as monoacrylates having alkoxylated chains e.g. ethoxy or poly ethylene oxide structure e.g. polyethylene glycol monoacrylates, preferably methoxy polyethyleneglycol 350 methacrylate, polypropylene glycol monoacrylates (egSR 607 from Sartomer Co), ethoxy ethoxyethyl acrylate (EOEOEA), ethyltriethylene glycol methacrylate, ethoxylated phenoxy ethyl acrylate, monomethoxy neopentyl glycol propoxylate monoacrylate (Photomer 8127 from Henkel);

amino-(meth) acrylates or amine-(meth) acrylate safts, eg N,N-dimethylaminoethyl acrylate (DMAEA), tertiary-butylaminoethyl methacrylate; hydrochloride or toluene sulphonate or other salt of DMAEA; and

unsaturated acid chlorides, preferably (meth)acryloyl chloride.

Polymer backbones of particular interest are copolymers comprising:

50 to 90 mole % of N,N-dimethylacrylamide, dimethylaminoethyl methacrylate or methyl acrylate; and

10 to 50 mole % of tertiary-butylaminoethyl methacrylate, maleic anhydride, methyl acrylate or N,N-dimethylacrylamide.

Other polymer backbones of particular interest are terpolymers comprising:

90 to 95 mole % of N,N-dimethylacrylamide,

0.01 to 5 mole % of maleic anhydride; and

0.01 to 5 mole % of methyl acrylate, ethyltriethylene glycol methacrylate or methoxy polyethyleneglycol 350 methacrylate.

The most preferred polymer backbone comprises:

50 mole % of N,N-dimethylacrylamide; and

50 mole % of tertiary-butylaminoethyl.

The method of introducing the unsaturated functionalities into the polymer backbone may include various known methods, which include, for example, reacting groups containing reactive hydrogen atoms, such as those attached to oxygen, nitrogen or sulfur, found on the polymer backbone with an unsaturated acid chloride compound. The unsaturated acid chloride is preferably (meth)acryloyl chloride. For example, acryloyl chloride may react with an amine group on the polymer backbone in order to introduce an unsaturated amide functionality into the polymer backbone.

An alternative method involves the acid chloride monomer being copolymerised into the polymer backbone. The backbone is then reacted with an unsaturated monomer which contains a reactive hydrogen atom, such as those attached to oxygen, nitrogen or sulfur. The unsaturated monomer may be a (meth)acrylate having mono- or multi-hydroxy functional group(s), an amino-(meth) acrylate or an amine-(meth) acrylate salt. The unsaturated monomer is preferably selected from hydroxy ethyl methacrylate or tertiary-butylamino ethyl (meth)acrylate. For example, acryloyl chloride may be a monomer on the polymer backbone, which is then reacted with a (meth) acrylate having mono- or multi-hydroxy functional group(s), such as 2-hydroxyethyl methacrylate, in order to introduce an unsaturated ester functionality into the polymer backbone.

A preferred method of introducing the unsaturated functionality is to functionalise a polymer backbone comprising a tertiary-butylaminoethyl methacrylate unit using acryloyl chloride.

The method of introducing the unsaturated functionalities into the polymer backbone may also include, for example, reacting groups containing reactive hydrogen atoms, such as those attached to oxygen, nitrogen or sulfur, found on the polymer backbone with a monomeric anhydride compound. The monomeric anhydride may be an acrylic anhydride, preferably maleic anhydride or itaconic anhydride. For example, maleic anhydride may react with a hydroxy group of the polymer backbone in order to introduce an unsaturated ester functionality into the polymer backbone.

An alternative method involves the monomeric anhydride monomer being copolymerised into the polymer backbone. The monomeric anhydride is preferably an acrylic anhydride. The backbone is then reacted with an unsaturated monomer which contains a reactive hydrogen atom, such as those attached to oxygen, nitrogen or sulfur.

A preferred method of introducing the unsaturated functionality is to functionalise the polymer backbone which comprises a maleic anhydride monomer with 2-hydroxyethyl (meth)acrylate.

The method of introducing the unsaturated functionalities into the polymer backbone may also include, for example, reacting groups containing reactive hydrogen atoms, such as those attached to oxygen, nitrogen or sulfur, found on the polymer backbone with a monomeric epoxide compound. The monomeric epoxide may be an acrylated epoxide, preferably glycidyl methacrylate. For example, glycidyl methacrylate may react with an amine group of the polymer backbone in order to introduce an unsaturated functionality into the polymer backbone.

An alternative method involves the monomeric epoxide being copolymerised into the polymer backbone. The monomeric epoxide is preferably an acrylated epoxide. The backbone is then reacted with an unsaturated monomer which contains a reactive hydrogen atom, such as those attached to oxygen, nitrogen or sulfur. The unsaturated monomer may be a (meth)acrylate having mono- or multi-hydroxy functional group(s), an amino-(meth) acrylate or an amine-(meth) acrylate salt. The unsaturated monomer is preferably hydroxy ethyl methacrylate or tertiary-butylamino ethyl (meth)acrylate. For example, glycidyl methacrylate may be a monomer on the polymer backbone, which is then reacted with 2-hydroxyethyl methacrylate in order to introduce an unsaturated functionality into the polymer backbone.

A preferred method of introducing the unsaturated functionality is to functionalise the polymer backbone which comprises a glycidyl methacrylate monomer with 2-hydroxyethyl (meth)acrylate.

The method of introducing the unsaturated functionalities into the polymer backbone may also include, for example, subjecting the polymer to an esterification or transesterification reaction. Hydroxy groups on the polymer backbone may be esterified with an unsaturated acid, preferably (meth)acrylic acid.

Carboxylic acid groups on the polymer backbone may be esterifled with an unsaturated hydroxyl containing monomer, preferably a (meth)acrylate having mono- or multi-hydroxy functional group(s), more preferably hydroxyethyl (meth)acrylate.

An ester group contained within the polymer backbone may undergo a tranesterification reaction with an ester. For example, a methyl acrylate monomer within the backbone may undergo reaction with a (meth)acrylate having mono- or multi-hydroxy functional group(s), preferably hydroxy ethyl acrylate.

The method of introducing the unsaturated functionalities into the polymer backbone may also include, for example, quaternising a tertiary amine group on the polymer backbone with an unsaturated chloride. A preferred unsaturated chloride is allyl chloride.

The method of introduction of unsaturated functionalities into the polymer backbone may also include reacting groups containing hydrogen atoms, such as those attached to oxygen, nitrogen on sulphur found on the polymer backbone with an acid chloride compound.

The acid chloride is of the formula (1):

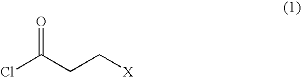

wherein X may be a halide, preferably chloride, an ammonium group NR₃, a sulphonium group SR₂ or an alkoxy group such as OR, where R is a C₁ to C₈alkyl group, preferably R is methyl or ethyl. The carbon atom adjacent to the substituent X may be further substituted by an R group.

The counterions for the cationic sulphonium and ammonium groups may be halide, acetate or acrylate or any suitable counter ion.

A compound of formula (1) may react with an amine group of the polymer backbone to form an amide in the polymer backbone, then in order to introduce an unsaturated amide functionality into the polymer backbone, a base is used to remove the X group and a hydrogen on the adjacent carbon.

The base may be any suitable base, such as a tertiary amine, or any amine groups on the polymer backbone may act as the base.

These methods of introducing the unsaturated functionality are known, and other methods exist. The preferred unsaturated functionality is a vinyl functionality.

The prepolymer may comprise from 1 to 50 unsaturated bonds, preferably the prepolymer comprises 1 to 20. More preferably the prepolymer comprises 5 to 10 unsaturated bonds.

The prepolymer may be charged, for example, as a result of a quaternisation reaction to introduce an unsaturated functionality into the polymer backbone. Preferred prepolymers of the present invention are anionic or cationic, more preferred prepolymers possess a cationic charge.

However the scope of the invention is not limited to compositions comprising charged prepolymers; the prepolymer may be non-ionic. Any charge which does exist on the prepolymer may be neutralised by the inclusion of an organic acid in the composition. The organic acid may be any organic acid which is soluble in the monomer contained in the composition. Such acids include carboxylic acids and sulfonic acids. Preferred organic acids include citric acid, adipic acid and benzoic acid.

The presence of an organic acid will affect the final pH of the composition, which may be any value. Preferred pH values are in the range of pH 4 to pH 12. More preferably, the pH of the composition is not lower than pH 6.

After radiation curing of the composition, any water which comes into contact with the composition will result in swelling, but the organic acid will also be ionised, thus neutralising the charged prepolymer. Any water which comes into contact before the curing of the composition will also ionise the organic acid, resulting in neutralisation of the charged prepolymer.

The composition may comprise between 10 to 90% of the prepolymer, based on the total weight of the composition, preferably between 30 to 70% by weight and most preferably between 40 to 60% by weight.

The molecular weight of the prepolymer may range from 1000 to 500,000. Preferably the molecular weight is below 100, 000, and more preferably the molecular weight ranges from 5000 to 40,000.

The monomer in which the polymer is dissolved is preferably liquid in the temperature range of 10 to 40 degrees C., most preferably liquid at room temperature. The monomer in which the polymer is dissolved may be selected from the following.

(meth) acrylates having mono- or multi-hydroxy functional group(s) eg. hydroxy ethyl acrylate (HEA), hydroxy ethyl (meth)acrylate (HEMA), hydroxy propyl acrylate (HPA), hydroxy propyl (meth)acrylate (HPMA); glycerol mono-acrylate; trimethylolpropane mono-acrylate, acrylated epoxides eg glycidyl methacrylate, acrylated amino alcohols and amino polyols and alkoxylated amines for example, acid functional acrylate and a hydroxyl functional primary amine such as tris(hydoxymethyl)aminomethane;

acrylamide and its derivatives eg N-hydroxymethylacrylamide, N-tris(hydroxymethyl)methyl acrylamide, other N-alkyl or N-alkoxy substituted acrylamides eg N,N-dimethyl acrylamide and acrylamide derivatives such as acrylamidosulphonic acid and its salts;

ether and polyether (meth) acrylates such as monoacrylates having alkoxylated chains e.g. ethoxy or poly ethylene oxide structure e.g. polyethylene glycol monoacrylates, preferably methoxy polyethyleneglycol 350 methacrylate or methoxy polyethyleneglycol 550 methacrylate, polypropylene glycol monoacrylates, ethoxy ethoxyethyl acrylate (EOEOEA), ethyltriethylene glycol methacrylate, ethoxylated phenoxy ethyl acrylate, monomethoxy neopentyl glycol propoxylate monoacrylate (Photomer 8127 from Henkel); and

unsaturated N-substituted amides, eg N-vinyl formamide, N-vinyl caprolactam, N-vinyl pyrolidone.

Preferred monomers include N,N-dimethylacrylamide, N-vinyl formamide, 2-hydroxyethyl acrylate, 2-hydroxyethyl methacrylate and ethyltriethylene glycol methacrylate. The most preferred monomer is N,N-dimethylacrylamide.

A single monomer or a blend of monomers selected from those listed above, may be used n the composition.

One or more photoinitiators may be selected from the groups below:

for free radical reaction of acrylate by UV radiation or visible light radiation:

acetophenone type e.g. 2-hydroxy-2-methyl-1-phenyl-propan-1-one (Darocur 1173 “RTM”)

acyl phosphine oxide eg Irgacure 1800 “RTM”;

benzoin type eg benzil dimethyl ketal (Irgacure 651 “RTM”);

benzophenone type;

thioxanthone type eg sopropylthioxanthone (ITX); and

other sensitiser and co-initiator for Wand visible light curing e.g. triethanolamine, other amine alcohols, Michler's Ketone, eosin.

Those photoinitiators recognised by the registered trade marks Darocur and Irgacure are suitable for the present invention.

For cationic reaction of vinyl ether or epoxy system example photoinitiators are aryl diazonium salts or aryl sulphonium salt, and aryl metal complexes such as Ciba CG24-061 “RTM”.

The composition may comprise between 0.01 and 20% by weight of photoinitiator, based on the total weight of the composition, preferably between 2 and 12% by weight.

Examples of bases that can be added include hydroxides, alkoxides, carbonates, carbamates, and hydrogen carbonates, di- and tn-basic phosphates or citrates,—of ammonium and of Group and II metals including sodium, potassium, magnesium, and calcium.

Organic bases such as amines eg triethanolamine or triethylamine (TEA) or morpholines (eg Nmethylmorpholine, MeM) or piperidines or tris(dimethylaminomethyl)phenol can also be used. In the absence of pre-dissolving in water or other diluent, the bases that are solid are used as powders, dispersed in the liquid components of the formulation. Bases are usually added to compositions containing acid functional acrylates.

Examples of added salts that may be used include halides, acetates, sulphates, carboxylated and phosphates of metals and ammonium or other amine/substituted ammonium counter-ions.

Examples of solvents which may be added include alcohols, glycols polyols, ethers and alkoxylated solvents. Examples include ethanol, methanol, isopropanol, ethylene glycol, propylene glycol, polyalkylene oxides, glycerol, trimethylolpropane, alkoxylated derivatives and ethers of the above (e.g. Photonols from Henkel). Levels of added solvents, if used, are preferably lower than 25% by weight of the total composition. However, the present compositions preferably-contain no solvent. Water may also be used as a solvent. However, the present compositions preferably contain no water.

Addition of surfactant up to 40% of the total composition weight can increase swell response. Example surfactants which can be used with or without water can be non-ionic, eg alkoxylated amines, alcohols, esters, oils, fatty acids, nonyiphenol and ethanolamides and sorbitan esters, alkyl aryl polyether alcohols eg Triton X100 “RTM” (from Rohm & Haas), or anionic or cationic, or amphoteric. Surfactants can help to stabilise same systems with dispersed salt or base or other undissolved solid.

Addition of a blowing agent which can generate gas when contacted with water or on heating (eg during exposure to UV lamp and/or other application source of heat) can increase the swell response in some cases. Examples are sodium bicarbonate, sodium carbonate, ammonium carbonate, ammonium bicarbonate with or without organic or inorganic acid (eg acetic acid, citric acid, oxalic acid, tartaric acid or keto-acid, or hydroxy acids such as lactic acid, etc), or NaAl(SO₄)₂, NaH₂PO₄ or NaBH₄ or C₆N₆, BaN₆, azo compounds such as azodicarbonamide etc. It will be seen that some such as of those blowing agents such as carbonates, hydrogen carbonates and some phosphate derivatives, may usefully act as both as blowing agent and base in certain formulations.

Foamed structures can be produced by simple use of hydroxide bases such as sodium hydroxide, although the mechanism of foam formation is not clear.

Addition of fillers such as inorganic particles (e.g. fumed silica, mica) or polymer powders or fibres, e.g. polyethylene powder, may increase swelling response in certain systems.

Addition of hydrophilic fibre, water soluble fibre or hydrophilic surface treated fibre can help to increase swell response in certain formulations. Examples include ground cellulosic fibres, polyvinyl alcohol fibre.

Addition of oligomer with radiation polymerisation functionality and phosphoric acid/ester helps to increase adherability to certain substrates. Examples are phosphoric acid diacrylate, hydroxymethylmethacrylate-phosphate and styrene phosphonic acid.

The composition may further comprise a crosslinking agent, such as a low molecular weight multifunctional (meth) acrylate. Known crosslinking agents which may be used in the present composition include methylene bis acrylamide, ethylene glycol di-(meth)acrylate, di-(meth)acrylamide, cyanomethyl(meth)acrylate or vinyloxyethyl(meth)acrylate. A preferred cross linking agent is pentaerythritol triacrylate. The amounts of crosshnking agent may be in the range of 100 to 2000 ppm, preferably in the range of 200 to 1200 ppm.

The type of radiation used to cure the composition may be any suitable source of radiation such as infra-red, ultra-violet, microwave, electron beam or heat radiation. A preferred form of radiation is ultra-violet.

The composition may be prepared in a multi-step process comprising the initial production of the polymer backbone, functionalisation of the polymer backbone by the addition of unsaturated bonds along the polymer backbone, isolation of this intermediate and mixing with the monomer in which the prepolymer is to be dissolved, optionally with the addition of one or more photonitiators and/or photosensitisers.

The preparation of the ethylenically unsaturated functionalised prepolymer may be carried out in any number of standard ways.

The polymer backbone may be prepared by polymerisation of the monomer or monomers, preferably in an aprotic solvent, using an appropriate initiator. Known initiators include peroxy type initiators and azo type initiators. For example, Luperox 11M75 “RTM” or tertiary-butyl perpivalate, may be used with cationic monomers and Vazo 67 “RTM” may be used with anionic monomers.

After polymerisation is complete, the polymer backbone is functionalised by introducing unsaturated groups into the polymer backbone. Functionalisation occurs via the substitution of a hydrogen on the polymer backbone, so an aprotic solvent is preferably used. Preferred solvents include ethyl acetate and butyl acetate.

A preferred method of functionalisation is the reaction of acryloyl chloride with an amine group of the polymer backbone.

Once the prepolymer has been formed, the solvent is removed by any standard method. Such a method may include the addition of an inhibitor, the application of a vacuum to the prepolymer/solvent mixture to remove the solvent, then the addition of water. Before, during or after the removal of the solvent, the organic acid may be added. Subsequently the water may be removed resulting in a liquid prepolymer, preferably all of the water is removed resulting in a solid prepolymer. The water may be removed by any standard procedure, including spray drying and the use of dry nitrogen. The solvent removal and drying steps may be combined by spray drying the prepolymer directly from the solvent.

After the drying stage, the solid prepoymer is preferably ground in order to reduce the particle size and aid the prepolymer dissolution.

The functionalised prepolymer is then dissolved in the monomer, and any photoinitiators or photosensitisers may also be added.

In a further aspect of the invention, there is provided a cable or cable component having a water swellable coating prepared from a pourable, radiation curable, liquid composition which has been subjected to radiation curing; the pourable, radiation curable, hquid composition comprising an ethylenically unsaturated polymer dissolved in water; the ethylenically unsaturated polymer having radiation polymerisable functionality.

In accordance with the present invention there is also provided a cable or cable component coated with a pourable, radiation curable, liquid composition comprising an ethylenically unsaturated polymer dissolved in water; the ethylenically unsaturated polymer having radiation polymerisable functionality.

In accordance with the present invention there is also provided a method of coating a cable or cable component with a water swellable coating, the method comprising the steps of:

coating the cable or cable component with a pourable, radiation curable, liquid composition comprising an ethylenically unsaturated polymer dissolved in water; the ethylenically unsaturated polymer having radiation polymerisable functionality; and

subjecting the coated cable or cable component to radiation in order to cure the pourable, radiation curable, liquid composition.

By the term ‘cable’ we include cables such as, for example, fibre-optic cables, power cables, copper telecommunication cables, and blown fibre units.

By the term ‘cable component’ we include for fibre-optic cables components such as, for example, strength members (which are usually made from glass, reinforced plastic or compacted steel); tubes (which are usually made from polymers such as, for example, polyester, polyolefins, polyethylenes, PVC; or metals such as, for example, steel, aluminium, or stainless steel); optical fibres; optical ribbon fibres; tapes (which are usually mafe from glass, aramid, steel, aluminium and non-wovens); yarns (which are usually made from polymeric materials such as, for example, polyethylene, PVC, nylon, ethylene-propylene-diene monomers); conductors; and rip cords.

By the term ‘cable component’ we include for power cables components such as, for example, conductors, tape, under sheath and over sheath.

By the term ‘cable component’ we include for copper telecommunication cables components such as, for example, insulated conductors, tapes, strength members, yarns, and sheathing materials. Preferably, the pourable liquid, radiation curable composition is water swellable upon radiation curing.

The coating may additionally comprise: one or more photoinitiators and/or photosensitisers and an organic acid.

The coating may further comprise: a base, an inorganic salt, a small amount of organic solvent, a blowing or foaming agent, a surfactant or dispersant, an adhesion promoter or tackifing resin, a fibre or filler, or a crosslinking agent.

Other possible additives include coupling agents, air release agents, inhibitors, wetting agents, lubricants or waxes, stabilisers, antioxidants and pigments.

The final compositions of coating will depend on a number of factors including the required processing speed, coating thickness, water swelling or blocking response in terms of speed and extent, the nature of the cable or cable component to which the coating is to be applied, and the nature of solutions in which it is required to function (ie absorb).

The radiation polymerisable polymer and its method of preparation has been described previously. The other components have also been previously described.

The composition may comprise between 10 to 100% of the prepolymer, based on the total weight of the composition.

The preparation of the ethylenically unsaturated functionalised prepolymer may be carried out in any number of standard ways.

The polymer backbone may be prepared by polymerisation of the monomer or monomers, preferably in an aprotic solvent, using an appropriate initiator. Known initiators include peroxy type initiators and azo type initiators. For example, Luperox 11M75 “RTM” or tertiary-butyl perpivalate, may be used with cationic monomers and Vazo 67 “RTM” may be used with anionic monomers.

After polymerisation is complete, the polymer backbone is functionalised by introducing unsaturated groups into the polymer backbone. Functionalisation occurs via the substitution of a hydrogen on the polymer backbone, so an aprotic solvent is preferably used. Preferred solvents include ethyl acetate and butyl acetate.

A preferred method of functionalisation is the reaction of acryloyl chloride with an amine group of the polymer backbone.

Once the prepolymer has been formed, the solvent is removed by any standard method. Such a method may include the addition of an inhibitor, the application of a vacuum to the prepolymer/solvent mixture to remove the solvent, then the addition of water. Before, during or after the removal of the solvent, the organic acid may be added. Subsequently the water may be removed resulting in a liquid prepolymer, preferably all of the water is removed resulting in a solid prepolymer. The water may be removed by any standard procedure, including spray drying and the use of dry nitrogen. The solvent removal and drying steps may be combined by spray drying the prepolymer directly from the solvent.

After the drying stage, the solid prepoymer is preferably ground in order to reduce the particle size and aid the prepolymer dissolution.

The functionalised prepolymer is then dissolved in water, and any photoinitiators or photosensitisers may also be added.

The compositions of the present invention can have a range of swell response times from seconds to minutes after contact with water. The cured coating can swell, for example, at a range of 8 times or more over original thickness. Swell heights in excess of 60 times the original thickness are possible.

The liquid pourable, radiation curable composition of the present invention may also be used as a gel blocking agent which will absorb water to form a gel which prevents further ingress of water.

The invention will now be described with reference to the following Figures:

FIG. 1 shows in cross section a loose tube optical fibre cable;

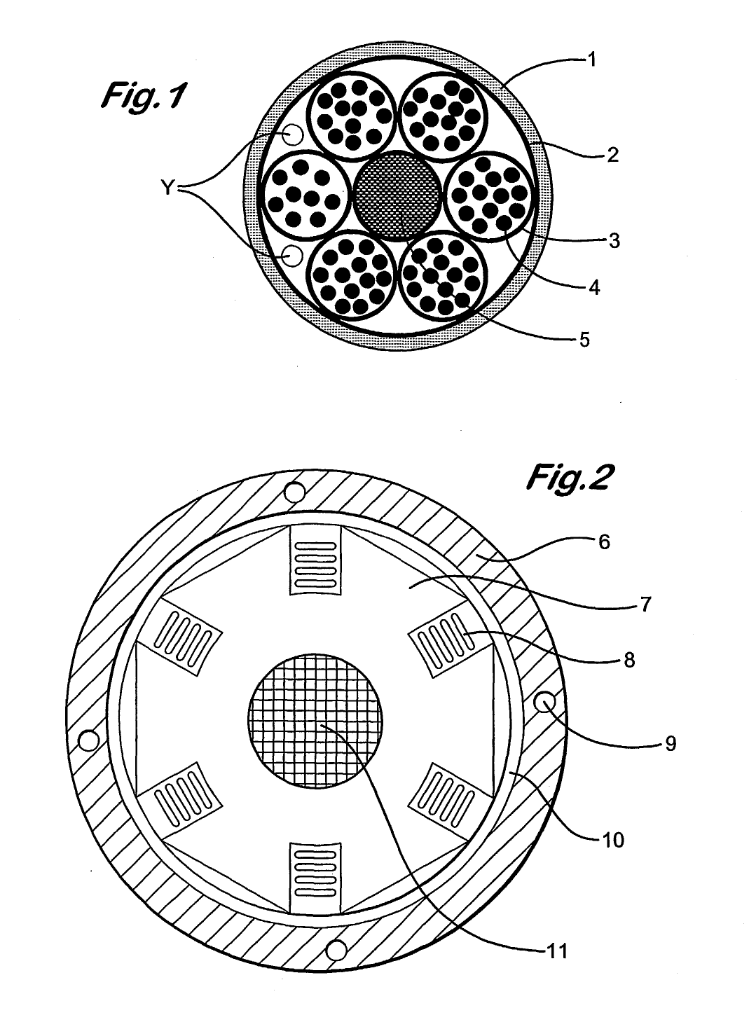

FIG. 2 shows in cross section a slotted core optical fibre cable;

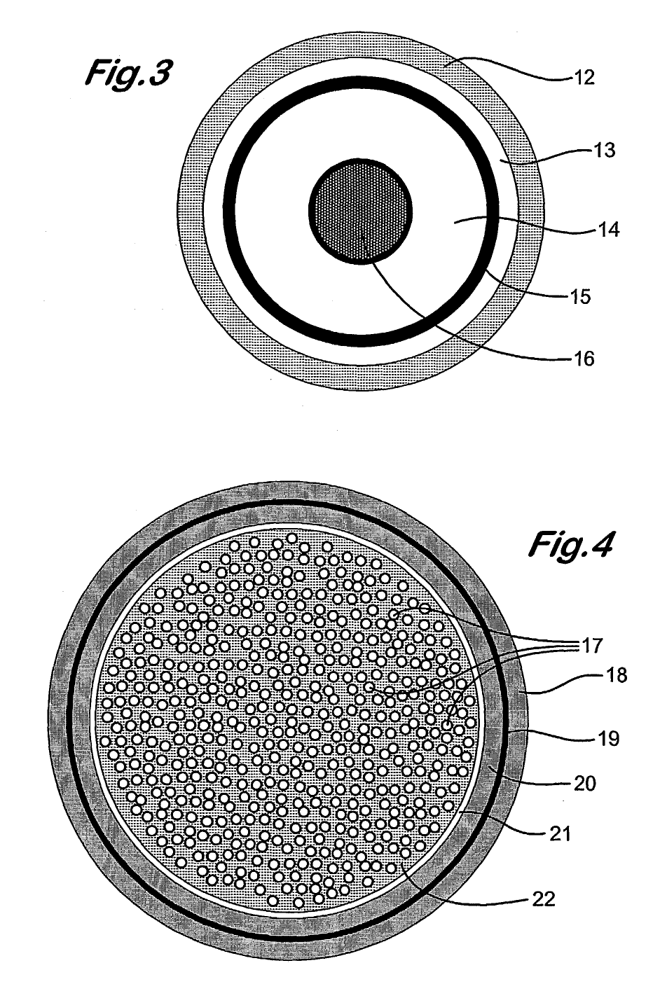

FIG. 3 shows in cross section a crosslinked polyethylene power cable; and

FIG. 4 shows in cross section a copper telecommunications cable.

The loose tube optical fibre cable in FIG. 1 includes a sheath 1, a tape 2, a loose tube 3, an optical fibre 4, a central strength member 5 and a yarn Y.

The slotted core optical fibre cable in FIG. 2 includes a sheath 6, a slotted core 7, an optical fibre ribbon 8, a rip cord 9, a tape 10 and a central strength member 11.

The crosslinked polyethylene power cable in FIG. 3 includes an outer sheath 12, an armour 13, an inner sheath 14, a semi-conductive tape 15 and a conductor 16.

The copper telecommunications cable in FIG. 4 includes insulated copper conductors 17, an outer sheath 18, shielding metallic tape 19, an inner sheath 20, paper tape 21 and petroleum jelly 22.

Any of the cables and the cable components shown in the Figures can be coated with the water swellable coating prepared from the pourable, radiation curable, liquid composition.

The pourable, radiation curable, liquid composition may also be used as a gel blocking agent in the cables shown in the Figures.

The following examples further illustrate the present invention:

### EXAMPLE I

The Preparation Of The Ethylenically Unsaturated Functionalised Prepolymer:

To a stirred reactor containing 250 g of ethyl acetate and 1.33 g tertiary-butyl perpivalate at reflux was added a monomer feed composed of 75 g N,N-dimethylacrylamide and 75 g tertiary-butylaminoethyl methacrylate over a period of two hours. An initiator feed composed of 2.66 g of tertiary-butyl perpivalate dissolved in 55 g of ethyl acetate was added over a period of two hours and fifteen minutes. After the additions were complete, the reactor contents were held for a further period of one hour at reflux in order to effect complete polymerisation before being cooled to 30 degrees C. After cooling, 3.6 g of acryloyl chloride and 00375 g of phenothiazine were dissolved in 120 g of ethyl acetate, and the solution was added to the stirred reactor contents over a period of 30 minutes. The contents of the reactor were stirred for a further 30 minutes, and then a vacuum was applied to remove the ethyl acetate which was then replaced, via a solvent swap, with 9.95 g of citric acid dissolved in 377.6 g of water. The product was a 30% aqueous solution of a 20,000 molecular weight copolymer, comprising about 50% N. N-dimethylacrylamide and 50% tertiary-butylaminoethyl methacrylate in the form of a citric acid salt, functionalised with an average of 5 vinyl groups per polymer chain.

### EXAMPLE 2

Preparation Of The Swellable Composition:

The aqueous solution from example I was dried under a nitrogen blanket and then ground using a pestle and mortar. The solid was then dissolved in N,N,-dimethylacrylamide to form a 30% by weight solution, based on the weight of the total formulation. The solution was then mixed with 10% by weight of the total formulation, of DARACUR 1173 “RTM”.

### EXAMPLE 3

Evaluation Of Swell Performance:

The composition from example 2 was coated on to Melinex 542 “RTM” at a thickness of 24 microns using a K-Bar Number 3. The coated sample was then passed under a lab scale UV lamp twice, at a line speed of 10 metres per second. After this curing step, a circle of 80 mm diameter was cut from the sample, and placed, coated side up, into a swelling cup of internal diameter 82 mm. A circle of 80 mm diameter of chemically bonded non woven polyethylene was then placed on top of the sample. A piston was inserted into the cup, which was free to move. The swelling cup assembly was then placed into a digital micrometer, such as a MT25B Micrometer with an ND221 Digital Display unit, and the readout was set to zero. 100 cm³ of deionised water was placed into the swelling cup, and then the swell height was measured with time. The results are shown in the following table I:

TABLE I

| Swell Height (microns) | Time (seconds) |
|---|---|
| 120 | 30 |
| 400 | 40 |
| 800 | 50 |
| 1200 | 60 |
| 1600 | 80 |
| 1800 | 100 |
| 1800 | 200 |
| 1800 | 300 |
| 1800 | 400 |
| 1800 | 500 |

These results show that the present composition provides excellent swell height and swell speed.

### EXAMPLE 4

Coating of an Optical Fibre:

The swellable composition from example 2 was coated on to a dual acrylate-coated single mode optical fibre (shown as numeral 4 in FIG. 1) by immersing the optical fibre in the swellable composition and pulling the optical fibre through an annular die to produce a uniform coating having a thickness of 24 microns. The optical fibre coated with the swellable composition was then passed under a lab scale UV lamp twice, at a line speed of 10 metres per second, to produce a water swellable coating.

THE optical fibre having the water swellable coating was used in the manufacture of a loose tube optical fibre cable (shown in FIG. 1). A water-blocking grease-type material was nor required around the optical fibre because of the water swellable coating on the optical fibre.

1. A cable or cable component having a water swellable coating prepared from a pourable, radiation curable, liquid composition which has been subjected to radiation curing; the pourable, radiation curable, liquid composition comprising an ethylenically unsaturated polymer dissolved in a monomer; the ethylenically unsaturated polymer having radiation polymerisable functionality.

2. A cable or cable component coated with a pourable, radiation curable, liquid composition comprising an ethylenically unsaturated polymer dissolved in a monomer; the ethylenically unsaturated polymer having radiation polymerisable functionality.

3. A method of coating a cable or cable component with a water swellable coating, the method comprising the steps of:
coating the cable or cable component with a pourable, radiation curable, liquid composition comprising an ethylenically unsaturated polymer dissolved in a monomer; the ethylenically unsaturated polymer having radiation polymerisable functionality; and
subjecting the coated cable or cable component to radiation in order to cure the pourable, radiation curable, liquid composition.

4. The cable or cable component or the method of coating a cable or cable component as claimed in any one of claims 1-3, wherein the pourable, radiation curable, liquid composition contains no water or organic solvent.

5. The cable or cable component or the method of coating a cable or cable component as claimed in any one of the preceding claims, wherein the ethylenically unsaturated polymer in the pourable, radiation curable, liquid composition is formed from at least one monomer which is polymerised to form a polymer backbone; unsaturated functionalities are then introduced into the polymer backbone.

6. The cable or cable component or the method of coating a cable or cable component as claimed in claim 5, wherein the polymer backbone is formed from at least one monomer which is selected from groups consisting of C₁ to C₂₀alkyl (meth) acrylates, (meth) acrylates having mono- or multi-carboxylic acid or sulphonic acid functionality, salts of (meth) acrylates having mono- or multi-carboxylic acid or sulphonic acid functionality, (meth) acrylates having a hydroxy functional group, acrylamide, acrylamide derivatives, ether and polyether (meth) acrylates, amino-(meth) acrylates or amine-(meth) acrylate salts and unsaturated acid chlorides.

7. The cable or cable component or the method of coating a cable or cable component as claimed in claims 5 or 6, wherein the unsaturated functionality is introduced by reaction of the polymer backbone with an unsaturated acid chloride compound, an unsaturated monomer which contains a reactive hydrogen atom, a monomeric anhydride compound, a monomeric epoxide compound or an unsaturated chloride.

8. The cable or cable component or the method of coating a cable or cable component as claimed in any one of the preceding claims, wherein the ethylenically unsaturated polymer in the pourable, radiation curable liquid composition contains from 1 to 50 unsaturated bonds.

9. The cable or cable component or the method of coating a cable or cable component as claimed in any one of the preceding claims, wherein the ethylenically unsaturated polymer in the pourable, radiation curable, liquid composition is anionic or cationic.

10. The cable or cable component or the method of coating a cable or cable component as claimed in any one of the preceding claims, wherein the ethylenically unsaturated polymer in the pourable, radiation curable, liquid composition is non-ionic.

11. The cable or cable component or the method of coating a cable or cable component as claimed in any one of the preceding claims, wherein the ethylenically unsaturated polymer in the pourable, radiation curable, liquid composition has a molecular weight in the range from 1000 to 500,000.

12. The cable or cable component or the method of coating a cable or cable component as claimed in any one of the preceding claims, wherein the pourable, radiation curable, liquid composition comprises from 10 to 90% by weight, based on the weight of the composition, of the ethylenically unsaturated polymer.

13. The cable or cable component or the method of coating a cable or cable component as claimed in any one of the preceding claims, wherein the monomer in which the ethylenically unsaturated polymer is dissolved is liquid in the temperature range of 10 to 40 degrees C.

14. The cable or cable component or the method of coating a cable or cable component as claimed in any one of the preceding claims, wherein the monomer in which the ethylenically unsaturated polymer is dissolved is selected from the group consisting of (meth) acrylates having mono- or multi-hydroxy functional group(s), acrylamide, acrylamide derivatives, ether and polyether (meth) acrylates and unsaturated N-substituted amides.

15. The cable or cable component or the method of coating a cable or cable component as claimed in any one of the preceding claims, wherein the pourable, radiation curable, liquid composition comprises one or more photoinitiators and/or photosensitisers.

16. The cable or cable component or the method of coating a cable or cable component as claimed in claim 15, wherein the pourable, radiation curable, liquid composition comprises between 0.01 and 20% by weight of photoinitiator, based on the total weight of the composition.

17. The cable or cable component or the method of coating a cable or cable component as claimed in any one of the preceding claims, wherein the pourable, radiation curable, liquid composition comprises an organic acid.

18. The cable or cable component or the method of coating a cable or cable component as claimed in any one of the preceding claims, wherein the pourable, radiation curable, liquid composition comprises a crosslinking agent.

19. A cable or cable component having a water swellable coating prepared from a pourable, radiation curable, liquid composition which has been subjected to radiation curing; the pourable, radiation curable, liquid composition comprising an ethylenically unsaturated polymer dissolved in water; the ethylenically unsaturated polymer having radiation polymerisable functionality.

20. A cable or cable component coated with a pourable, radiation curable, liquid composition comprising an ethylenically unsaturated polymer dissolved in water; the ethylenically unsaturated polymer having radiation polymerisable functionality.

21. A method of coating a cable or cable component with a water swellable coating, the method comprising the steps of:
coating the cable or cable component with a pourable, radiation curable, liquid composition comprising an ethylenically unsaturated polymer dissolved in water; the ethylenically unsaturated polymer having radiation polymerisable functionality; and
subjecting the coated cable or cable component to radiation in order to cure the pourable, radiation curable, liquid composition.

22. The cable or cable component or the method of coating a cable or cable component as claimed in any one of claims 19 to 21, wherein the pourable, radiation curable, liquid composition comprises an ethylenically unsaturated polymer having radiation polymerisable functionality dissolved in water and is water swellable upon radiation curing.

23. The cable or cable component or the method of coating a cable or cable component as claimed in any one of claims 19 to 22, wherein the ethylenically unsaturated polymer is formed from a monomer or monomers which are polymerized to form a polymer backbone, then unsaturated functionalities are introduced into the polymer backbone.

24. The cable or cable component or the method of coating a cable or cable component as claimed in claim 23, wherein the polymer backbone is formed from a monomer or monomers of the type selected from groups consisting of C₁ to C₂₀alkyl (meth) acrylates, (meth) acrylates having mono- or multi-carboxylic acid or sulphonic acid functionality, salts or (meth) acrylates having mono- or multi-carboxylic acid or sulphonic acid functionality, (meth) acrylates having a hydroxy functional group, acrylamide, acrylamide derivatives, ether and polyether (meth) acrylates, amino-(meth) acrylates or amine-(meth) acrylate salts and unsaturated acid chlorides.

25. The cable or cable component or the method of coating a cable or cable component as claimed in any one of claims 19 to 24, wherein the unsaturated functionality is introduced by reaction of the polymer backbone with an unsaturated acid chloride compound, an unsaturated monomer which contains a reactive hydrogen atom, a monomeric anhydride compound, a monomeric epoxide compound or an unsaturated chloride.

26. The cable or cable component or the method of coating a cable or cable component as claimed in any one of claims 19 to 25, wherein the ethylenically unsaturated polymer contains from 1 to 50 unsaturated bonds.

27. The cable or cable component or the method of coating a cable or cable component as claimed in any one of claims 19 to 26 which comprises 10 to 100% by weight, based on the weight of the composition of the ethylenically unsaturated polymer.

28. The cable or the method of coating a cable as claimed in any one of the preceding claims, wherein the cable is a fibre-optic cable, a power cable, or a telecommunications cable.

29. The cable component or the method of coating a cable component as claimed in any one of the preceding claims, wherein the cable component is an optical fibre, a strength member, a tube, an optical ribbon fibre, a tape, a yarn, a conductor, an insulator, a rip cord, an under sheath and an over sheath.
